(19) United States
(12) Patent Application Publication
(10) Pub. No.: US 2020/0299555 A1
(43) Pub. Date: Sep. 24, 2020

(54) COATING STRUCTURE AND METHOD THEREOF OF RADIATION-RESISTANT ADHESIVE

(71) Applicant: BECQUEREL & SIEVERT CO., LTD., New Taipei City (TW)

(72) Inventor: Chi-Kuang Chen, New Taipei City (TW)

(21) Appl. No.: 16/360,003

(22) Filed: Mar. 20, 2019

(51) Int. Cl. C09J 183/04; C09J 9/00; C09J 11/04; C09J 11/06

(52) U.S. Cl. CPC C09J 183/04; C09J 9/00; C08K 3/36; C09J 11/06; C09J 11/04

(57) ABSTRACT

A coating structure and the method thereof of the radiation-resistant adhesive, which main structure comprises a radiation-resistant adhesive which is composed by mixing a colloid and a Barium sulfate set beside the colloid; wherein the colloid is composed by at least one Polydimethyloxane defined in the colloid, at least one Decane coupling agent defined at the side of the Polydimethyloxane, and at least one gas-phase Silicon dioxide defined at the side of the Decane coupling agent; thereby bonding the Barium-plates with each other and fill the gaps to achieve the effects of radiation-resistant, bonding, waterproof, crack resistance, and good elasticity.

### (a) TECHNICAL FIELD OF THE INVENTION

The present invention provides a coating structure and the method thereof of the radiation-resistant adhesive having radiation-resistant, bonding, waterproof, crack resistance, and good elasticity.

### (b) DESCRIPTION OF THE PRIOR ART

Lead has many negative effects on the human body, but there are many things in life that will add lead as a raw material for manufacturing. For example, in the manufacture of paint, many unscrupulous manufacturers add lead as a manufacturing material for paint, so there are many countries control and limit the amount of lead in the paint; and the earlier gasoline also contained a lot of lead, so after discovering the damage of lead to the human body in modern times, it gradually changed to unleaded gasoline. However, some places still use lead-containing items, such as the radiology room of the hospital. The radiology room of the hospital uses the lead-containing wall surface as a radiation-preventing faceplate to achieve the anti-radiation effect. However, due to the progress of the times, people pay more and more attention to health, so the lead-free wall surface of the radiology room also has an alternative item, that is, using a Barium-plate as a wall surface to block radiation. However, although the Barium-plate is harmless to the human body and can block radiation; it is necessary to use an adhesive with the radiation-blocking effect between the Barium-plates in order to have a complete anti-radiation function.

### SUMMARY OF THE INVENTION

The main objectives of the invention is lied in that: The effects of bonding, waterproof, crack resistance, and good elasticity are produced via the colloid, and the radiation-resistant function is achieved by using the Barium sulfate at the same time.

In order to achieve the above objectives, the main structure of the present invention comprises: a radiation-resistant adhesive mixed with at least one colloid and at least one Barium sulfate defined at the side of the colloid, at least one Polydimethyloxane defined in the colloid, at least one Decane coupling agent defined in the colloid and located at the side of the Polydimethyloxane, and at least one gas-phase Silicon dioxide defined in the colloid and located at the side of the Decane coupling agent.

With the above structure, the user can use the radiation-resistant adhesive to bond the Barium-plates with each other and fill the gaps between the Barium-plates; and since the colloid is composed of Polydimethyloxane, Decane coupling agent, and gas-phase Silicon dioxide; it can produce the effects of bonding, waterproof, crack resistance, and good elasticity; and it can generate the function of radiation blocking via the Barium sulfate to achieve the anti-radiation effect.

With the above techniques, the present invention can break through the problem that the adhesive between the Barium-plates needs to have anti-radiation function; and so as to achieve the practicality and progressiveness with the above advantages.

### BRIEF DESCRIPTION OF THE DRAWINGS

FIG. 1 is a schematic block diagram of the structure of the preferred embodiment of the present invention.

FIG. 2 is a hierarchical schematic diagram of the preferred embodiment of the present invention.

FIG. 3 is a step schematic diagram of the preferred embodiment of the present invention.

FIG. 4 is an adhesion schematic diagram of the preferred embodiment of the present invention.

FIG. 5 is a schematic diagram of the wall surface of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

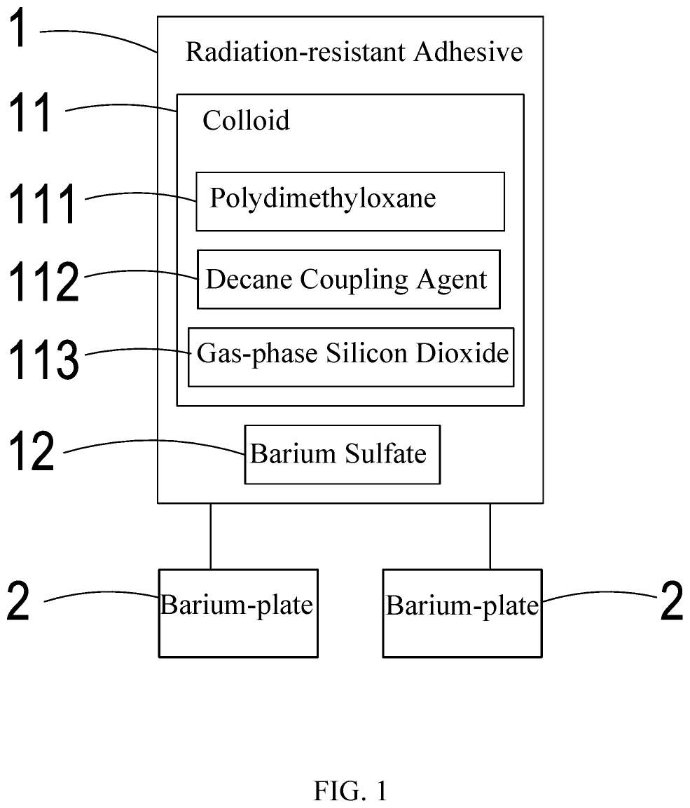

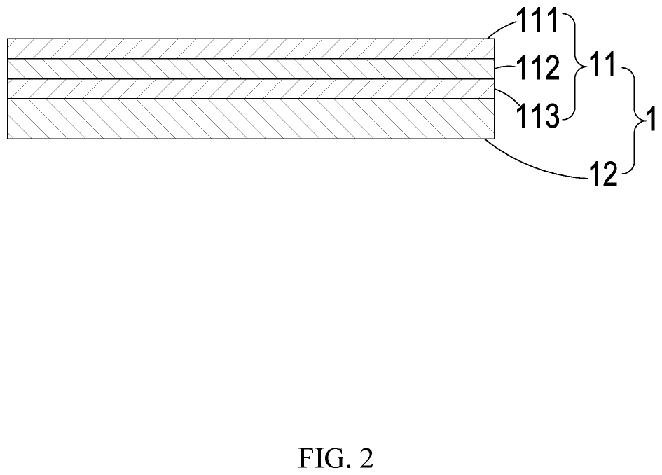

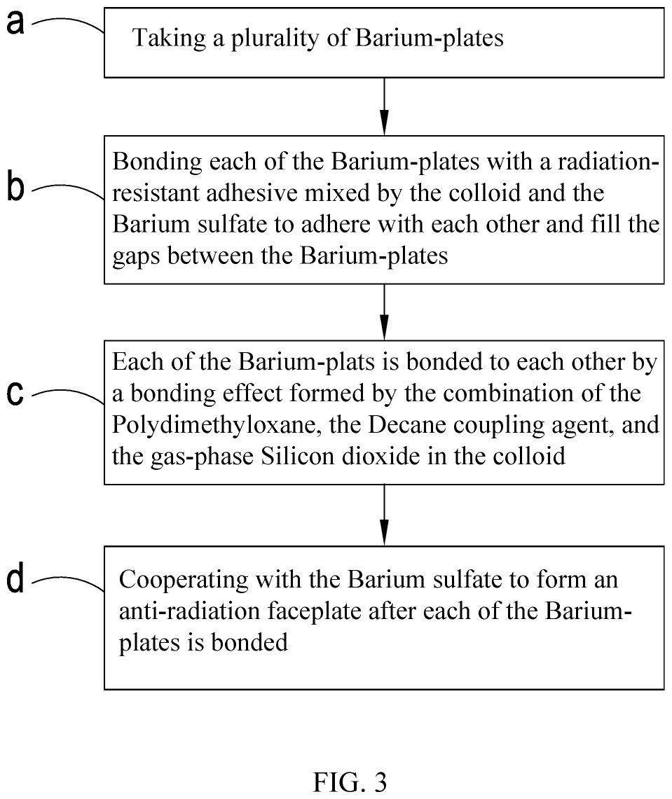

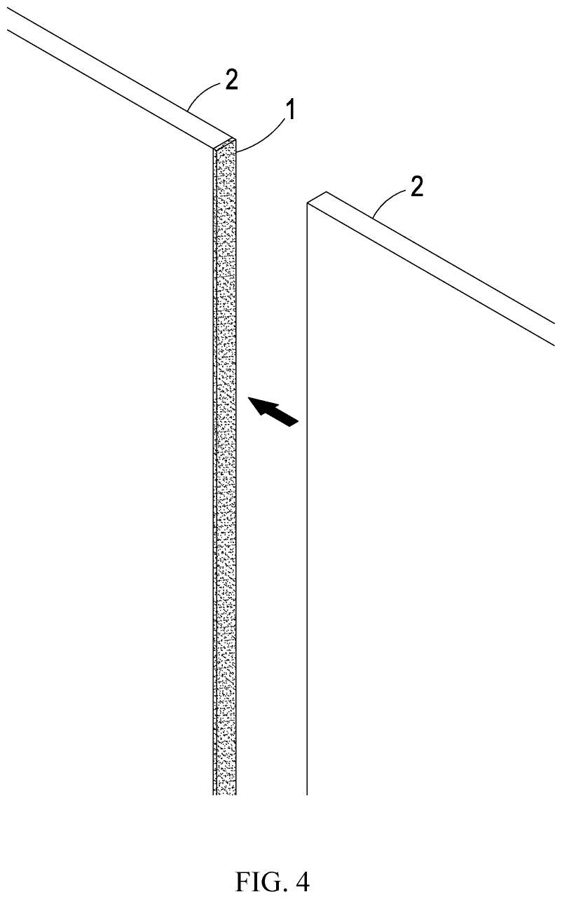

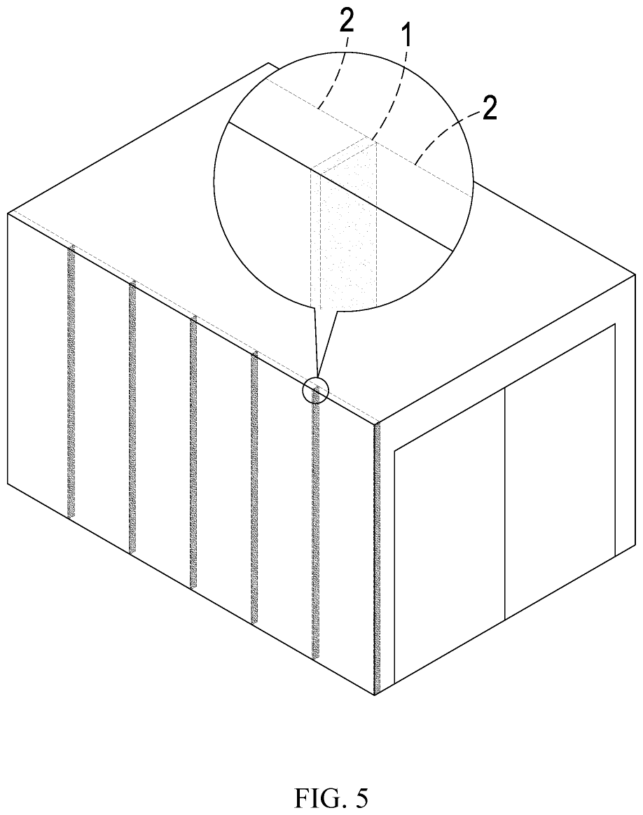

Please refer to FIG. 1 to FIG. 5, which are the schematic block diagram of the structure to the schematic diagram of the wall surface of the preferred embodiment of the present invention; it will be apparent from the figures that the present invention comprises: a radiation-resistant adhesive 1 which is obtained by mixing a colloid 11 and a Barium sulfate 12 defined at the side of the colloid 11, wherein the colloid 11 is a composed by a Polydimethyloxane 111, a Decane coupling agent 112 defined at a side of the Polydimethyloxane 111, and a gas-phase Silicon dioxide 113 defined at a side of the Decane coupling agent 112; thereby, the colloid 11 has a function similar to that of the Silicone; wherein the Barium sulfate 12 accounts for 65% to 75% by weight of the radiation-resistant adhesive 1, the Polydimethyloxane 111 accounts for 24% to 34% by weight of the radiation-resistant adhesive 1, the Decane coupling agent 112 accounts for 0.5% to 1% by weight of the radiation-resistant adhesive 1, and the gas-phase Silicon dioxide 113 accounts for 0.5% to 1% by weight of the radiation-resistant adhesive 1.

The method for using the radiation-resistant adhesive 1 of the present invention comprises the following steps:
(a) Taking a plurality of Barium-plates;
(b) Bonding each of the Barium-plates with a radiation-resistant adhesive mixed by the colloid and the Barium sulfate to adhere with each other and fill the gaps between the Barium-plates;
(c) Each of the Barium-plats is bonded to each other by a bonding effect formed by the combination of the Polydimethyloxane, the Decane coupling agent, and the gas-phase Silicon dioxide in the colloid; and
(d) Cooperating with the Barium sulfate to form an anti-radiation faceplate after each of the Barium-plates is bonded.

As the steps described above, the user can use the radiation-resistant adhesive 1 to adhere the Barium-plates with each other and fill the gaps between the Barium-plates; and the colloid 11 is composed by mixing the Polydimethyloxane 111, Decane coupling agent 112, and the gas-phase Silicon dioxide 113; therefore, it can have a similar effect to the Silicone (Silicone is a paste having a bonding effect when stored, but after drying; it will form a state similar to the plastic having elasticity; so it can be used to bond many items; and it will have the effects of having elasticity, crack resistance, and waterproof after bonding.); therefore, the colloid 11 can also have the advantages of bonding, waterproof, crack resistance, and good elasticity at the same time; and by bonding each of the Barium-plates 2, it can cooperate with the Barium sulfate 12 to achieve the function of blocking radiation, thereby having the anti-radiation function; therefore, the Barium-plate 2 can be combined with the radiation-resistant adhesive 1 to form a blocking faceplate in the radiology room.

Therefore, the technical key of the coating structure and the method thereof of the radiation-resistant adhesive of the present invention for improving the conventional technology is:
1. Producing the advantages of bonding, waterproof, crack resistance, and good elasticity by the Polydimethyloxane 111, the Decane coupling agent 112, and the gas-phase Silicon dioxide 113 in the colloid 11; thereby sewing as the bonding agent between the Barium-plates 2.
2. Producing the anti-radiation effect by the Barium sulfate 12; thereby cooperating with the Barium-plate to serve as an anti-radiation faceplate.

I claim:

1. A coating structure of the radiation-resistant adhesive, which mainly comprises:
a radiation-resistant adhesive provided for bonding a plurality of Barium-plates and filling the gaps between the Barium-plates, wherein the radiation-resistant adhesive is composed by mixing at least one colloid with at least one Barium sulfate defined at the side of the colloid;
at least one Polydimethyloxane defined in the colloid;
at least one Decane coupling agent defined in the colloid and located at the side of the Polydimethyloxane; and
at least one gas-phase Silicon dioxide defined in the colloid and located at the side of the Decane coupling agent.

2. The coating structure of the radiation-resistant adhesive according to claim 1, wherein the colloid accounts for 25% to 35% by weight of the radiation-resistant adhesive, and the Barium sulfate accounts for 65% to 75% by weight of the radiation-resistant adhesive.

3. The coating structure of the radiation-resistant adhesive according to claim 2, wherein the Polydimethyloxane accounts for 24% to 34% by weight of the radiation-resistant adhesive, the Decane coupling agent accounts for 0.5% to 1% by weight of the radiation-resistant adhesive, and the gas-phase Silicon dioxide accounts for 0.5% to 1% by weight of the radiation-resistant adhesive.

4. A method of using a radiation-resistant adhesive, the steps of which comprises:
(a) Taking a plurality of Barium-plates;
(b) Bonding each of the Barium-plates with a radiation-resistant adhesive mixed by the colloid and the Barium sulfate to adhere with each other and fill the gaps between the Barium-plates;
(c) Each of the Barium-plats is bonded to each other by a bonding effect formed by the combination of the Polydimethyloxane, the Decane coupling agent, and the gas-phase Silicon dioxide in the colloid; and
(d) Cooperating with the Barium sulfate to form an anti-radiation faceplate after each of the Barium-plates is bonded.

5. The method of using a radiation-resistant adhesive according to claim 4, wherein the colloid accounts for 25% to 35% by weight of the radiation-resistant adhesive in step (b), and the Barium sulfate accounts for 65% to 75% by weight of the radiation-resistant adhesive.

6. The method of using a radiation-resistant adhesive according to claim 5, wherein the Polydimethyloxane accounts for 24% to 34% by weight of the radiation-resistant adhesive in step (c), the Decane coupling agent accounts for 0.5% to 1% by weight of the radiation-resistant adhesive, and the gas-phase Silicon dioxide accounts for 0.5% to 1% by weight of the radiation-resistant adhesive.
